(19) United States
(12) Patent Application Publication
(10) Pub. No.: US 2026/0003314 A1
(43) Pub. Date: Jan. 1, 2026

(54) IMAGE FORMING APPARATUS

(71) Applicant: CANON KABUSHIKI KAISHA, Tokyo (JP)

(72) Inventor: MASUMI SONE, Kyoto (JP)

(21) Appl. No.: 19/242,012

(22) Filed: Jun. 18, 2025

(30) Foreign Application Priority Data
Jun. 27, 2024 (JP) 2024-103521

(51) Int. Cl. G03G 15/00; G03G 15/02; G03G 21/16; G03G 21/18

(52) U.S. Cl. CPC G03G 15/80; G03G 15/0283; G03G 21/1619; G03G 21/1652; G03G 21/1885

(57) ABSTRACT

An image forming apparatus includes an image forming unit, a frame body, a first unit secured to the frame body, a cable, and a guide unit configured to guide the cable. The guide unit includes a first guide portion having a first surface which faces to a first side and a second surface which is opposite to the first surface and faces to a second side. A first through hole penetrating from the first surface to the second surface is provided in the first guide portion. The first unit is arranged on the first side of the first guide portion. The cable includes a second-side part arranged on the second side of the first guide portion and along the second surface of the first guide portion, and a first-side part drawn out from the second side through the first through hole to the first side of the first guide portion.

### BACKGROUND

### Field of the Technology

This disclosure relates to an image forming apparatus, such as a printer, a copier, a facsimile, or a multifunction machine.

### Description of the Related Art

Image forming apparatuses, such as printers, copiers, facsimiles, and multifunction machines, which combine these functions integrally, include a plurality of electrical boards to operate electrical components, such as various motors, various sensors, and switches. For example, electrical boards, such as a high-voltage board that applies high voltage and a main control board that executes various control processes, are arranged on a rear side of an image forming apparatus body (hereinafter, referred to as an apparatus body). In addition, the image forming apparatuses include drive transmission units that incorporate motors for rotating components, such as photosensitive drums, developing sleeves, or intermediate transfer belts. The drive transmission units are also arranged on the rear side of the apparatus body. The drive transmission units are electrically connected to the high-voltage boards and the like through wire bundles, in which a plurality of cables are bundled, and the like. In the apparatus described in Japanese Patent Laid-Open No. 2004-126430, a wire bundle, which bundles a plurality of cables for applying charging voltages for four colors, developing voltages for four colors, and drum cleaning voltages for four colors, is routed to the high-voltage boards.

Recently, there is a strong demand for faster printing speeds and further miniaturization of the image forming apparatuses. To achieve higher speeds, the high-voltage boards and the drive transmission units are becoming larger, while the miniaturization of the apparatus bodies tends to lead to a decrease in space within the apparatus bodies. Therefore, securing adequate space for arranging wiring, such as the wire bundles, has become increasingly difficult.

### SUMMARY

According to one feature of the present disclosure, an image forming apparatus includes an image forming unit configured to form an image on a recording material, a frame body, a first unit secured to the frame body, a cable, and a guide unit configured to guide the cable. The guide unit includes a first guide portion having a first surface which faces to a first side of the first guide portion and a second surface which is opposite to the first surface and faces to a second side of the first guide portion, the second side being opposite to the first side in an intersecting direction that intersects with the first surface and the second surface. A first through hole penetrating from the first surface to the second surface is provided in the first guide portion. The first unit is arranged on the first side of the first guide portion. The cable includes a second-side part arranged on the second side of the first guide portion and along the second surface of the first guide portion, and a first-side part drawn out from the second side through the first through hole to the first side of the first guide portion.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an image forming apparatus of this embodiment.

FIG. 2 is a schematic diagram illustrating the image forming apparatus.

FIG. 3 is a schematic diagram illustrating the arrangement of electrical boards.

FIG. 4 is a perspective view illustrating a drive transmission unit.

FIG. 5 is an exploded perspective view illustrating the drive transmission unit.

FIG. 6 is a schematic diagram illustrating the drive transmission unit as viewed from a rear side.

FIG. 7 is a side view illustrating a fastening configuration of the drive transmission unit with respect to a rear-side plate.

FIG. 8 is a perspective view illustrating a high-voltage board unit and a wire bundle guide unit as viewed from the rear side of the image forming apparatus.

FIG. 9 is a perspective view illustrating the high-voltage board unit and the wire bundle guide unit as viewed from a front side of the image forming unit.

FIG. 10A is a perspective view illustrating the wire bundle guide unit.

FIG. 10B is an exploded perspective view illustrating the wire bundle guide unit.

FIG. 11A is a cross-sectional view illustrating the rear-side plate and the drive transmission unit before disengagement.

FIG. 11B is a cross-sectional view illustrating the rear-side plate and the drive transmission unit after the disengagement.

### DESCRIPTION OF THE EMBODIMENTS

### Image Forming Apparatus

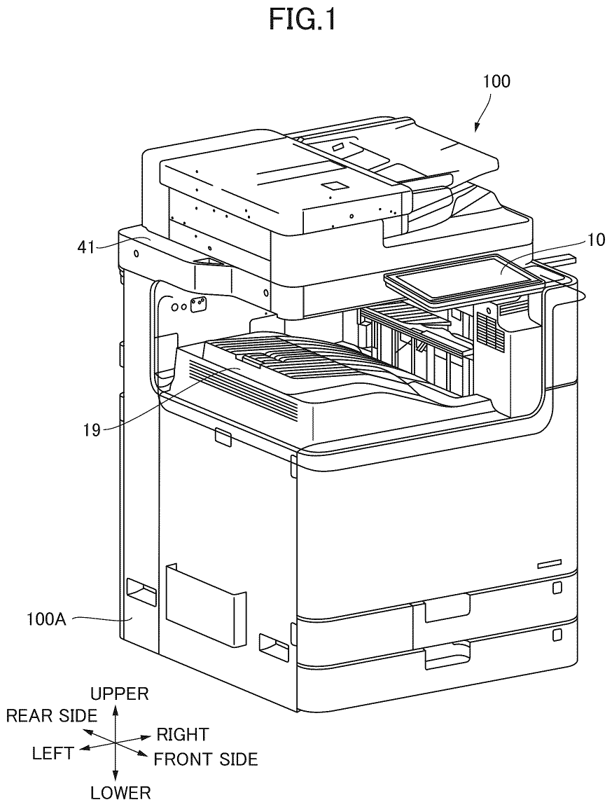

Hereinafter, this embodiment will be described. First, using FIGS. 1 to 3, an image forming apparatus of this embodiment will be described. In FIGS. 1 to 3, an in-body discharge type image forming apparatus 100 is illustrated as an example. The image forming apparatus 100 illustrated in FIG. 1 includes an apparatus body 100A and a document reading apparatus 41 that reads image information of a document, and, between the apparatus body 100A and the document reading apparatus 41, a sheet discharge tray 109 that supports a recording material S discharged from the apparatus body 100A is formed. The image forming apparatus 100 forms a toner image on the recording material in accordance with an image signal transmitted from the document reading apparatus 41 or an external device (not shown) such as a personal computer.

On the apparatus body 100A, an operation unit 10 including a display unit that can display various information, a key through which various information can be input in accordance with a user operation, and the like is disposed on a front side. To be noted, in this specification, a side on which the user stands when operating the operation unit 10 is referred to as a “front side (front)”, and the opposite side is referred to as a “rear side (rear)”. In addition, a left side when viewing the image forming apparatus 100 from the front side is referred to as the “left”, and a right side when viewing the image forming apparatus 100 from the front side is referred to as the “right”.

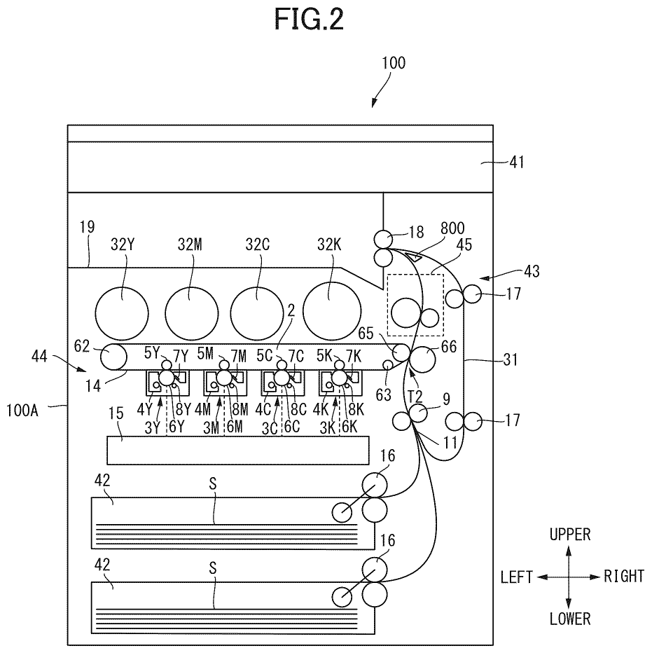

A conveyance process of the recording material in the image forming apparatus 100 will be described. As illustrated in FIG. 2, the recording material S is stored in a stacked form within cassettes 42, and is supplied to a conveyance path 11 one sheet at a time by each of supply rollers 16 in synchronization with the timing of image formation. In addition, the recording material S stacked on a manual feed tray may be supplied to the conveyance path 11 one sheet at a time. When conveyed to a registration roller 9 arranged midway along the conveyance path 11, subsequent to the skew correction and a timing adjustment of the recording material S by the registration roller 9, the recording material S is sent to a secondary transfer portion T2. The secondary transfer portion T2 is a transfer nip portion formed by a secondary transfer inner roller 65 and a secondary transfer outer roller 66, which are arranged to face each other. In the secondary transfer portion T2, by applying a secondary transfer voltage to the secondary transfer inner roller 65, the toner image is secondarily transferred from an intermediate transfer belt 14 onto the recording material S.

An image forming process of the image, which is delivered to the secondary transfer portion T2 in a synchronized timing with respect to the conveyance process of the recording material S to the secondary transfer portion T2 described above, will be described. First, image forming units 3Y, 3M, 3C, and 3K will be described. However, the image forming units 3Y, 3M, 3C, and 3K are configured almost identically except for a difference in toner colors used by developing units 4Y, 4M, 4C, and 4K, which are yellow, magenta, cyan, and black. Therefore, hereinafter, the image forming unit 3Y will be described as a representative, and the description of the other image forming units 3M, 3C, and 3K will be omitted.

The image forming unit 3Y includes a photosensitive drum 6Y, a charge unit 8Y, serving as a charge unit, the developing unit 4Y, serving as a developing unit, and a drum cleaner 7Y. A surface of the photosensitive drum 6Y is uniformly charged by the charge unit 8Y beforehand through the application of a charging voltage, and, thereafter, an electrostatic latent image is formed by an exposure unit 15 that is driven based on a signal of image information. The electrostatic latent image formed on the photosensitive drum 6Y is developed into the toner image using developer by the developing unit 4Y through the application of a developing voltage. Thereafter, a predetermined pressure force and a primary transfer voltage are applied by a primary transfer roller 5Y arranged to face the image forming unit 3Y across the intermediate transfer belt 14, and the toner image formed on the photosensitive drum 6Y is primarily transferred onto the intermediate transfer belt 14. Transfer residual toner slightly remained on the photosensitive drum 6Y after the primary transfer is collected by the drum cleaner 7Y, and the image forming unit 3Y again prepares for the next image forming process. To be noted, the image forming unit 3Y, serving as a process cartridge, is disposed so as to be integrally replaceable with respect to the apparatus body 100A.

The intermediate transfer belt 14 is stretched by the secondary transfer inner roller 65, and a plurality of stretch rollers 62 and 63, and is driven to move in a counter-clockwise direction. The image forming processes for each color, processed by the image forming units 3Y to 3K, are performed with timing that ensures a sequential overlap of the toner image onto the toner image of an upstream color, in a moving direction, which has been primarily transferred onto the intermediate transfer belt 14. As a result, finally, a full color toner image is formed on the intermediate transfer belt 14, and is conveyed to the secondary transfer portion T2. To be noted, transfer residual toner remaining after passing through the secondary transfer portion T2 is collected from the intermediate transfer belt 14 by a secondary transfer cleaner, not shown.

With the conveyance process and the image forming process each described above, the timing of the recording material S and the full color toner image is aligned at the secondary transfer portion T2, and the toner image is secondarily transferred from the intermediate transfer belt 14 onto the recording material S. Thereafter, the recording material S is conveyed to a fixing unit 45, and heat and pressure are applied by a fixing unit 45, so that the toner image is fixed on the recording material S. In a case of one-sided printing, the recording material S on which the toner image has been fixed as described above is discharged to the sheet discharge tray 19 by a sheet discharge roller 18, which rotates in a forward direction. On the other hand, in a case of duplex printing, the recording material S is conveyed by the sheet discharge roller 18, which rotates in the forward direction, until a trailing edge of the recording material S passes through a switching member 800. Thereafter, the sheet discharge roller 18 reverses its rotation direction, and conveys the recording material S to a duplex conveyance path 31 with a leading edge and the trailing edge of the recording material S reversed. Thereafter, the recording material S is again sent to the conveyance path 11 by a reconveyance roller 17. Since the subsequent conveyance and image forming processes on a second surface are the same as those described above, the description will be omitted.

To be noted, toner bottles 32Y to 32K storing replenishment toner for replenishing to the developing units 4Y to 4K are disposed above the intermediate transfer belt 14 in a mountable and removable manner with respect to a toner replenishment mechanism, not shown. From the toner bottles 32Y to 32K, the toners of each color are replenished in a timely and appropriate quantity to the corresponding developing units 4Y to 4K through the toner replenishment mechanism.

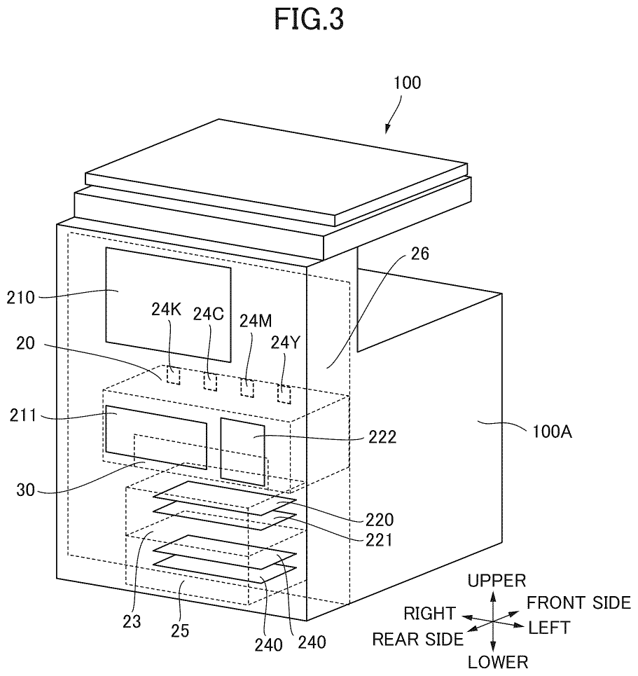

In the image forming apparatus 100, the operation unit 10 is disposed on the front side for user convenience, while, as illustrated in FIG. 3, a drive transmission unit 20 is disposed on the rear side. As described in detail below, the drive transmission unit 20, serving as a first unit, includes drive sources that generate a driving force to drive, for example, the photosensitive drums 6Y to 6K, the secondary transfer inner roller 65, the developing rollers 4Y to 4K, and a primary transfer roller contact-separation mechanism (not shown), serving as rotary members. The drive transmission unit 20 is removably mounted with screws to a rear-side plate 26, which forms part of a frame body of the apparatus body 100A. In addition, in this embodiment, a wire bundle guide unit 30 for guiding a wire bundle, in which a cable and a plurality of cables are bundled, is disposed on the front side of the drive transmission unit 20, and part of the wire bundle guide unit 30 overlaps part of the drive transmission unit 20 when viewed in a direction perpendicular to the rear-side plate 26. The wire bundle guide unit 30 is secured to the rear-side plate 26 with screws. The user can remove the drive transmission unit 20 from the rear-side plate 26 by disengaging the screws, without removing the wire bundle guide unit 30. To be noted, the primary transfer roller contact-separation mechanism is a mechanism to move the primary transfer rollers 5Y to 5K between positions in contact with the intermediate transfer belt 14 and positions separated from the intermediate transfer belt 14.

### Electrical Board

In addition, in the image forming apparatus 100, various electrical boards equipped with elements such as a central processing unit (CPU), memories, electronic components, electrical components, and connectors are disposed. On the rear side of the image forming apparatus 100, boards such as a main control board 211, which performs various controls in accordance with the execution of programs such as an image forming job, a sub-control board 210, which provides auxiliary support for some of the controls executed by the main control board 211, and a secondary transfer high-voltage board 222, which supplies the secondary transfer voltage to the secondary transfer inner roller 65, are disposed. Within the apparatus body 100A, a high-voltage board unit 23 and a power supply board unit 25 are vertically aligned and disposed on the rear-side plate 26 below the drive transmission unit 20. The drive transmission unit 20 is disposed on the rear-side plate 26 with a gap from the high-voltage board unit 23.

The high-voltage board unit 23, serving as a second unit, includes a charging high-voltage board 220, which applies a charging voltage to the charge units 8Y to 8K, and a developing high-voltage board 221, which applies a developing voltage to the developing units 4Y to 4K. The power supply board unit 25 includes a plurality of power control boards 240 that control electricity supplied from an external power source, and supplies power to, for example, the main control board 211, the sub-control board 210, the secondary transfer high-voltage board 222, the charging high-voltage board 220, and the developing high-voltage board 221. To be noted, the electrical boards are not limited to those described above, and boards such as a conveyance control board, which controls conveyance motors that drive, for example, the supply rollers 16, the registration roller 9, the sheet discharge roller 18, the reconveyance roller 17 (refer to FIG. 2) and the like for conveying the recording material S, may be disposed.

In addition, in this embodiment, four sensors 24Y, 24M, 24C, and 24K are disposed on the rear-side plate 26 to acquire information such as individual serial numbers and lifespan related data of the replaceable process cartridges. Since these sensors 24Y to 24K need to be arranged adjacent to the respective four process cartridges, the sensors 24Y to 24K are arranged to overlap the rear side of the drive transmission unit 20, which drives the photosensitive drums 6Y to 6K and the developing units 4Y to 4K. To transmit detection signals, the sensors 24Y to 24K are connected to the main control board 211 via cables, not shown.

Each of the electrical boards described above is connected to electrical components, such as various motors, various sensors, and switches, via cables, not shown, to operate these electrical components. In general, cables connected to each of the electrical components are often wired to the electrical board as a wire bundle, in which the cables are bundled. This facilitates maneuvering within the apparatus body 100A, and enables easy connection to the electrical board. In addition, for the transmission of various electrical signals (hereinafter, referred to as electrical signals), the electrical boards are connected to each other via wire bundles, not shown, as needed.

### Drive Transmission Unit

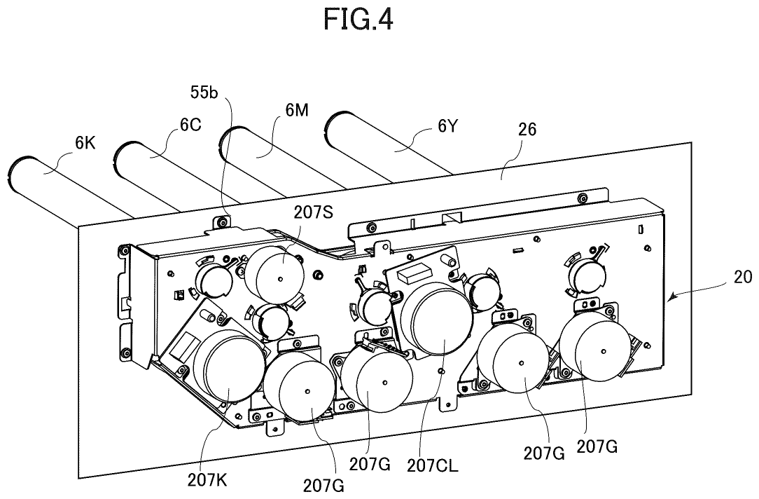

Next, with reference to FIG. 2, the drive transmission unit 20 will be described using FIGS. 4 to 7. FIG. 4 is a perspective view from the rear side of the image forming apparatus 100, illustrating the drive transmission unit 20, the rear-side plate 26, which is simplified, and the photosensitive drums 6Y to 6K engaged with the drive transmission unit 20. As illustrated in FIG. 4, the drive transmission unit 20 includes, for example, a drive source 207CL, a drive source 207K, a drive source 207S, and four drive sources 207G, in which a drive motor and drive gear are disposed. The drive transmission unit 20 rotatably drives three photosensitive drums 6Y, 6M, and 6C integrally with the single drive source 207CL, and rotatably drives remaining one photosensitive drum 6K independently from the others with the drive source 207K. In addition, the drive transmission unit 20 drives the secondary transfer inner roller 65 with the drive source 207K, the primary transfer roller contact-separation mechanism (not shown) with the drive source 207S, and the developing units 4Y to 4K with their respective four drive sources 207G.

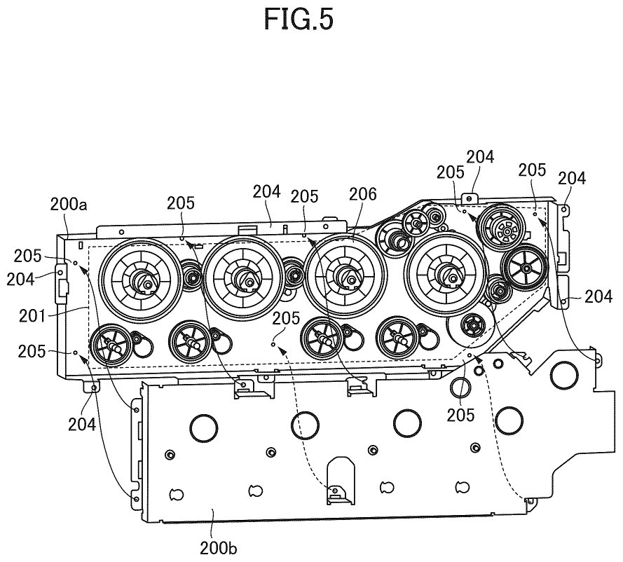

FIG. 5 is an exploded perspective view illustrating the drive transmission unit 20. As illustrated in FIG. 5, the drive from each of the drive sources (207CL. 207K, 207S, 207G) is transmitted to the photosensitive drums 6Y to 6K, the secondary transfer inner roller 65, the primary transfer roller contact-separation mechanism (not shown), and the developing units 4Y to 4K via a drive train 201 formed by numerous drive gears 206 disposed within the drive transmission unit 20. On the gear tooth surfaces of these drive gears 206, viscous grease is often applied to enhance lubrication or reduce noise during rotation. In such a case, if foreign substances such as toner or paper dust enter into the drive train 201, there is a risk that these substances may be retained due to the viscous grease and cause gear noise or obstruct the proper transmission of the drive.

Therefore, the drive transmission unit 20 is configured such that a first metal plate 200a and a second metal plate 200b are fastened with screws at fastening portions 205 in a manner sandwiching the drive train 201, so that the entry of the foreign substances such as the toner and paper dust into the drive transmission unit 20 is suppressed. The fastening portions 205 for fastening the second metal plate 200b to the first metal plate 200a are preferably disposed within the drive train 201 or adjacent to the drive train 201, so that it is possible to miniaturize the drive transmission unit 20.

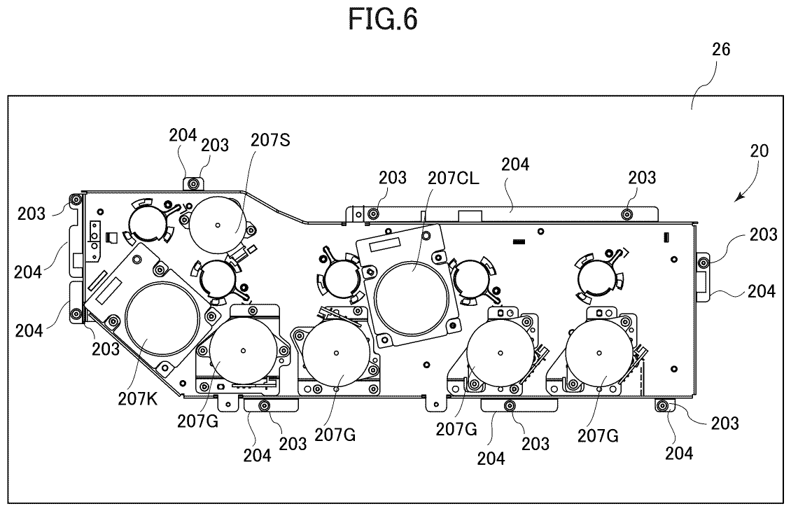

FIG. 6 is a schematic diagram illustrating the drive transmission unit 20 from the rear side. A plurality of fastening portions 204 are disposed on an outer circumferential portion of the first metal plate 200a, and, in this embodiment, the drive transmission unit 20 is fastened to the rear-side plate 26 of the image forming apparatus 100 with screws 203 through the fastening portions 204. The drive transmission unit 20 is fastened to the rear-side plate 26 with the plurality of screws 203 using a tool such as a screwdriver. Some of the plurality of screws 203 are arranged in the gap between the drive transmission unit 20 and the high-voltage board unit 23 (refer to FIG. 3), and fasten the drive transmission unit 20 to the rear-side plate 26.

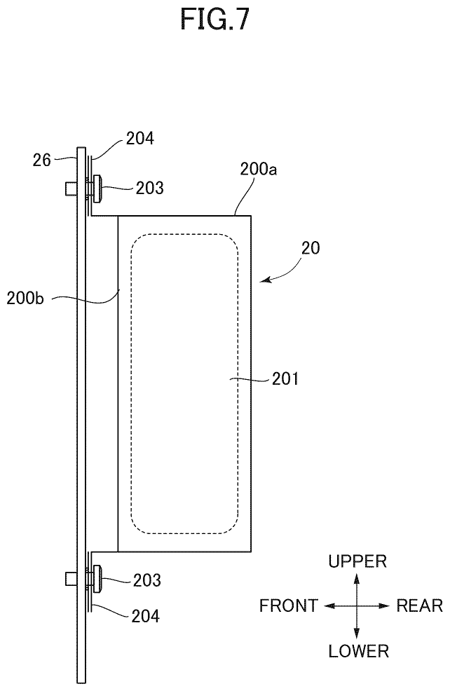

FIG. 7 is a side view illustrating a fastening configuration of the drive transmission unit 20 with respect to the rear-side plate 26. In this embodiment, as illustrated in FIG. 7, the drive train 201 is enclosed with the first and second metal plates 200a and 200b, and the drive transmission unit 20 is fastened to the rear-side plate 26 via the fastening portions 204 extended from the first metal plate 200a. Thereby, the entry of the foreign substances into the drive train 201 is suppressed.

On the rear side of the image forming apparatus 100, various boards, the drive transmission unit 20, and the like described above are collectively arranged, and a wire bundle connecting them is routed to minimize its length. If the length of the wire bundle is extended, it not only raises the cost but also increases the likelihood of noise contamination in the electrical signals. Further, there is a risk of catching the wire bundle during assembly, which may cause damage by tearing a cable sheath. Therefore, the wire bundle is routed in such a way that the length of the wire bundle becomes as short as possible.

In addition, it is important to ensure the assemblability, maintainability, and replaceability of the electrical components, such as various motors, various sensors, and switches. This is because various conditions, such as the progressive degradation of electrical components over time due to the operational duration of the image forming apparatus 100 and limited lifespans of the electrical components, may coincide and seldom lead to defects or the failure of the electrical components. Therefore, to facilitate the assembly or maintenance, or to expedite component replacement at the time of the failure, it is necessary to pay attention to the assemblability, replaceability, and maintainability of the electrical components. The same applies to various boards, and each board is allowed to be independently mounted and dismounted with respect to the apparatus body 100A. The drive transmission unit 20 and various electrical boards (210, 211, 220, 221, 222, 240) (refer to FIG. 3) disposed on the rear side of the image forming apparatus 100 become mountable and removable with respect to the apparatus body 100A when a rear cover, not shown, is removed. That is, the drive transmission unit 20 and various electrical boards (210, 211, 220, 221, 222, 240) are configured to be mounted and dismounted from the rear side of the apparatus body 100A.

Incidentally, as described above, the image forming apparatus 100 is required to be faster and more compact. In this regard, while various boards and the drive transmission unit 20 are becoming larger to increase speed, the miniaturization is reducing space within the apparatus body 100A. In that case, to efficiently use the space within the apparatus body 100A, wire bundle is routed even through a narrow gap beneath the drive transmission unit 20. However, even if the wire bundle is routed to ensure that the length of the wire bundle is as short as possible, there is a risk that the wire bundle may be caught when mounting and dismounting the drive transmission unit 20, and damage such as the tearing of the cable sheath may occur. That is, in a case of dismounting the drive transmission unit 20 from the rear-side plate 26, the user is required to remove the screw 203 (refer to FIG. 6) using the screwdriver. Since, at that time, the user is required to insert the screwdriver through the narrow gap beneath the drive transmission unit 20, there is a risk that the user may catch the wire bundle with the screwdriver and may damage the wire bundle.

Alternatively, when the user moves the drive transmission unit 20, there is a risk that the wire bundle may be caught and damaged by the drive transmission unit 20 itself.

### Wire Bundle Guide Portion

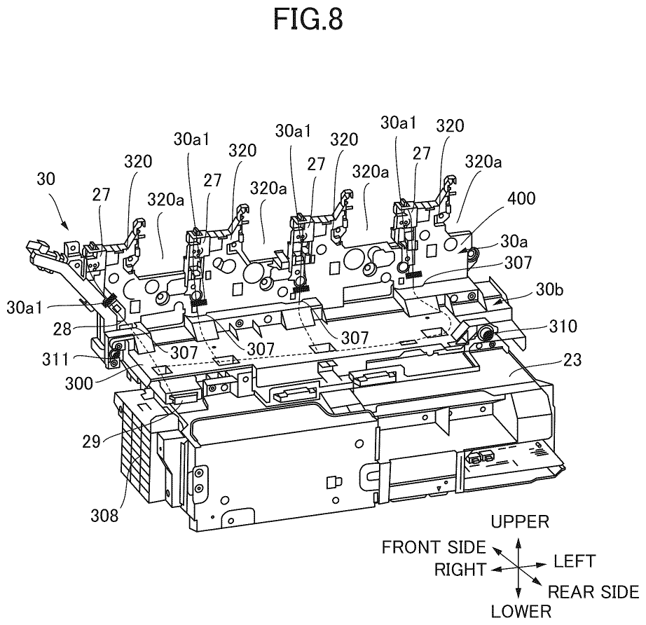

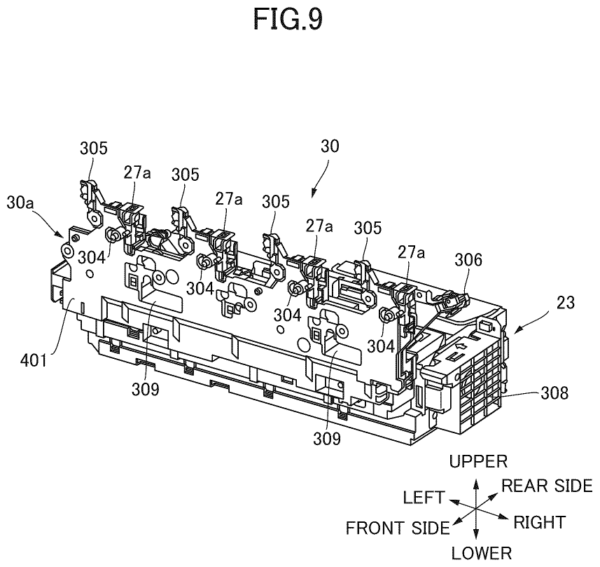

In this embodiment, taking into account the above, it is configured such that, even in a case where the wire bundle is routed through the narrow gap beneath the drive transmission unit 20, the wire bundle is guided while being protected to be less likely to be caught during mounting and dismounting operations of the drive transmission unit 20. Hereinafter, with reference to FIGS. 2 and 3, a wire bundle guide unit 30 that implements it will be described using FIGS. 8 to 11B. FIG. 8 is a perspective view illustrating the high-voltage board unit 23 and the wire bundle guide unit 30 when viewed from the rear side of the image forming apparatus 100 with the drive transmission unit 20 hidden. FIG. 9 is a perspective view illustrating the high-voltage board unit 23 and the wire bundle guide portion 30 when viewed from the front side of the image forming apparatus 100 with the back-side plate 26 and the drive transmission unit 20 hidden.

The wire bundle guide unit 30, serving as a guide unit, can be broadly divided into an upper guide plate 30a and a lower guide plate 30b. In the case of this embodiment, the upper guide plate 30a is extended from the lower guide plate 30b along the rear-side plate 26 toward the drive transmission unit 20 in a direction intersecting with the lower guide plate 30b, and is disposed to guide a wire bundle 28, which is routed from the drive transmission unit 20 toward the high-voltage board unit 23, toward the lower guide plate 30b.

### Upper Guide Plate

As illustrated in FIG. 8, the upper guide plate 30a, serving as a second guide plate or a second guide portion, includes four memory boards 27 on a surface 400 on a side opposite to the rear-side plate 26 (rear side), and, as illustrated in FIG. 9, the upper guide plate 30a includes four charging high-voltage contacts 304 (charging unit contacts), four developing high-voltage contacts 305 (developing unit contacts), and one secondary transfer high-voltage contact plate 306 on a surface 401 on the same side as the rear-side plate 26 (front side). The wire bundle guide unit 30 is electrically connected to the charging high-voltage board 220 and the developing high-voltage board 221 via contact plates. The charging high-voltage board 220 is electrically connected to the charging high-voltage contacts 304, and the developing high-voltage board 221 is electrically connected to the developing high-voltage contacts 305.

As illustrated in FIG. 8, the upper guide plate 30a includes four projecting shape portions 320 that project upward, and the projecting shape portions 320 form four engagement portions 320a that individually engage with the four drive sources 207G (refer to FIG. 4) of the drive transmission unit 20. To the projecting shape portions 320, the memory boards 27 are mounted on the surface 400 on the opposite side of the rear-side plate 26. The memory board 27 includes a non-volatile memory chip (not shown) and an electrode section 27a (refer to FIG. 9) for engaging with an apparatus body side electrode portion (not shown) disposed on the rear-side plate 26 to establish an electrical connection. Then, the wire bundle connected to the memory boards 27 is guided to a relay connector 29 disposed on the lower guide plate 30b. By connecting the wire bundle 28, which is guided, to the relay connector 29, the relay connector 29 is electrically connected to the main control board 211, and, thereby, relays the electrical signals in a manner capable of inputting and outputting between the memory boards 27 and the main control board 211.

In addition, the upper guide plate 30a includes a plurality of holding members 30al (second holding member) for guiding the wire bundle 28 to the lower guide plate 30b by holding the wire bundle 28 on the surface 400 on the opposite side of the rear-side plate 26. On the memory chip of the memory board 27, in accordance with the replacement of the process cartridge, information related to the replacement timing of the process cartridge, such as the individual serial number and usage history of the cartridge, is written and stored for the process cartridges of each color by the main control board 211. In this manner, by disposing the memory boards 27 on the wire bundle guide unit 30, rather than mounting the memory boards 27 onto the rear-side plate 26, it is possible to prevent damage to the wire bundle 28, and it is preferable since the replacement of the memory boards 27 becomes easier.

As illustrated in FIG. 9, the charging high-voltage contact 304 is an elastic body capable of extending and contracting in the front-rear direction, and is formed on the surface 401 on the side of the rear-side plate 26. The charging high-voltage contact 304 is pressed when the process cartridge is inserted into the apparatus body 100A, and a high voltage is applied from the charging high-voltage board 220 of the high-voltage board unit 23 to the charging units 8Y to 8K. Similarly, the developing high-voltage contact 305 is an elastic body capable of extending and contracting in the front-rear direction, is pressed when the process cartridge is inserted into the apparatus body 100A, and a high voltage is applied from the developing high-voltage board 221 of the high-voltage board unit 23 to the developing units 4Y to 4K.

By fastening the upper guide plate 30a described above to the rear-side plate 26 with screws, the wire bundle guide unit 30 is secured to the rear-side plate 26. In a state in which the wire bundle guide unit 30 is secured to the rear-side plate 26, when viewed in a direction perpendicular to the rear-side plate 26, tool holes 309 disposed in the upper guide plate 30a are positioned to overlap some of the fastening portions 204 (refer to FIG. 6), which are disposed in a lower part of the drive transmission unit 20. Some of the fastening portions 204, which are disposed in the lower part of the drive transmission unit 20, are exposed through the tool holes 309. The tool hole 309 (second through hole) is a through hole for passing a screwdriver, which is used for fastening the screw 203, serving as a fastening member, to some of the fastening portions 204, from outside the image forming apparatus 100. Therefore, with the wire bundle guide unit 30 secured to the rear-side plate 26, the user can fasten and unfasten the screw 203 with respect to the fastening portion 204 using a tool such as the screwdriver from the rear side of the apparatus body 100A. Thereby, since the user can independently dismount the drive transmission unit 20 with the wire bundle guide unit 30 mounted to the rear-side plate 26, the assemblability and replaceability of the drive transmission unit 20 are enhanced.

### Lower Guide Plate

The lower guide plate 30b is secured to the upper guide plate 30a with screws. As illustrated in FIG. 8, the lower guide plate 30b includes a secondary transfer high-voltage contact spring 310 (board side). The secondary transfer high-voltage contact spring 310 is an elastic body that extends toward the secondary transfer high-voltage board 222 arranged adjacently, and is pressed against the secondary transfer high-voltage board 222. The secondary transfer high-voltage contact spring 310 engages with a secondary transfer high-voltage contact spring 311 (contact side) on a contact surface of the upper and lower guide plates 30a and 30b. The secondary transfer high-voltage contact spring 311 is pressed against the secondary transfer high-voltage contact plate 306 in an upper part of the wire bundle guide unit 30. An end portion of the high-voltage contact spring 311 (contact side) is configured as a compression spring, and, upon fastening the upper and lower guide plates 30a and 30b with screws, the compression spring enables conduction between the high-voltage contact spring 310 (board side) and the high-voltage contact spring 311 (contact side). In addition, the high-voltage contact spring 311 (contact size) includes a spring portion at an end portion on a side of the secondary transfer high-voltage contact plate 306, and, when the spring portion is sandwiched by the secondary transfer high-voltage contact plate 306, the secondary transfer high-voltage contact plate 306 and the high-voltage contact spring 311 (contact side) are electrically connected. When the secondary transfer high-voltage contact plate 306 is pressed by an elastic body extending from the secondary transfer inner roller 65, a high-voltage is applied to the secondary transfer inner roller 65 by the secondary transfer high-voltage board 222.

The high-voltage board unit 23 holds the charging high-voltage board 220 and the developing high-voltage board 221 inside, and includes a fan 308 to cool them. The lower guide plate 30b is secured to the high-voltage board unit 23 with screws. Thereby, since the user can dismount the high-voltage board unit 23 with the wire bundle guide unit 30 mounted to the apparatus body, the assemblability and the replaceability of the high-voltage board unit 23 become enhanced.

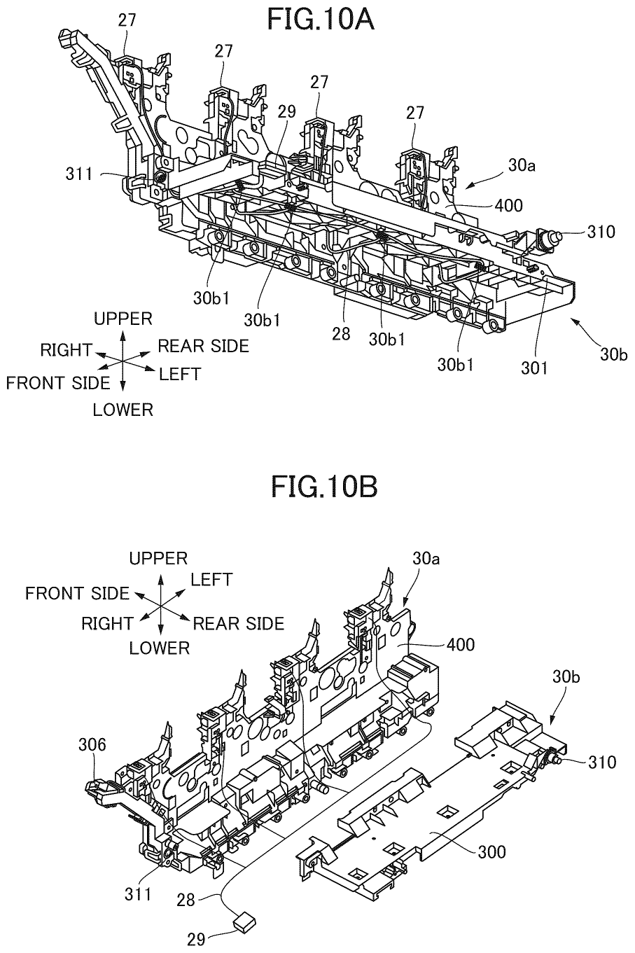

The lower guide plate 30b, serving as a first guide plate or a first guide portion, guides the wire bundle 28 with at least one part (second-side part) of the wire bundle 28 covered with respect to the drive transmission unit 20. The drive transmission unit 20 is arranged on a side of an upper surface 300 (first surface) of the lower guide plate 30b. As can be understood from FIGS. 8 and 10A, the lower guide plate 30b includes through holes 307 (first through holes) to pass the wire bundle 28 from the upper surface 300 (first surface) on the side of the drive transmission unit 20 (first unit side) to a lower surface 301 (second surface) opposite to the upper surface 300. The one part (second-side part) of the wire bundle 28 is arranged along the lower surface 301 on a side of the lower surface 301 of the lower guide plate 30b. Then, the other part (first-side part) of the wire bundle is drawn out from the side of the lower surface 301 through the through holes 307 to the side of the first surface of the lower guide plate 30b. In other words, on a second side to which the lower surface 301 of the lower guide plate 30b faces and that is opposite to the upper surface 300 across the lower surface 301 in an intersecting direction intersecting with the upper surface 300 and the lower surface 301, the one part (second-side part) of the wire bundle 28 is arranged along the lower surface 301. Then, the other part (first-side part) of the wire bundle is drawn out from the second side described above through the through holes 307 to a first side to which the upper surface 300 of the lower guide plate 30b faces and that is opposite to the lower surface 301 across the upper surface 300 in the intersecting direction.

As illustrated in FIG. 10B, the lower guide plate 30b is fastened to the upper guide plate 30a with screws in a state in which the wire bundle 28 extending from each of the memory boards 27 is routed on the first side along the surface 400 of the upper guide plate 30a extended in a direction intersecting with the lower guide plate 30b. Since the through holes 307 of the lower guide plate 30b exist in a configuration that the through holes 307 straddles the wire bundle 28, when fastening the wire bundle guide unit 30 to the rear-side plate 26 with screws, the wire bundle 28 is not sandwiched between the upper guide plate 30a and the rear-side plate 26. Then, the lower guide plate 30b includes a plurality of holding members 30b1 (first holding members) holding the wire bundle 28 against the lower surface 301. The wire bundle 28, which passes through the through holes 307 and is routed on the lower surface 301, is guided to the relay connector 29 by being held by the holding members 30b1.

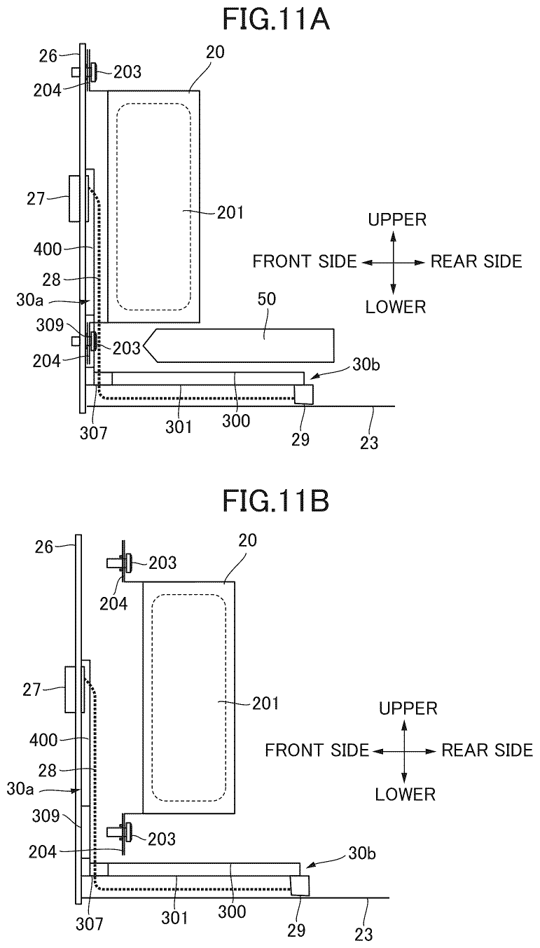

FIG. 11A illustrates a state immediately before an external screwdriver 50 releases the fastening of the drive transmission unit 20 to the rear-side plate 26 with the screw 203. FIG. 11B illustrates a state in which the drive transmission unit 20, whose fastening to the rear-side plate 26 using the screw 203 has been released, is dismounted. As illustrated in FIG. 11A, there is a gap between the drive transmission unit 20 and the upper surface 300 of the lower guide plate 30b to allow the insertion of a tool (such as a screwdriver) for executing fastening work using the screw 203.

In the gap between the drive transmission unit 20 and the high-voltage board unit 23, the lower guide plate 30b is arranged between the screw 203 and the high-voltage board unit 23, and guides the wire bundle 28 by changing an orientation of the wire bundle 28, which is directed from the drive transmission unit 20 to the high-voltage board unit 23, toward a direction away from the rear-side plate 26. In a case of removing the screw 203 of the drive transmission unit 20 with the screwdriver 50, the user is required to pass the screwdriver 50 through the gap between the drive transmission unit 20 and the high-voltage board unit 23. In this embodiment, since the wire bundle 28 is routed in a state of being guided from the upper surface 300 of the lower guide plate 30b to the lower surface 301 and being covered by the lower guided plate 30b, the wire bundle 28 does not exist in the gap in which the fastening work of the screw 203 using the screwdriver 50 is performed. Therefore, damage, such as the screwdriver catching the wire bundle 28 and tearing the cable sheath, is less likely to occur.

As illustrated in FIG. 11B, when the drive transmission unit 20 is inserted into and removed from the rear-side plate 26 in the front-rear direction, the fastening portion 204 of the drive transmission unit 20 passes through a position adjacent to the lower guide plate 30b. In this embodiment, as described above, since the wire bundle 28 is in a state of being covered by the lower guide plate 30b, the wire bundle 28 does not exist in an insertion/removal locus where the fastening portion 204 passes. Therefore, damage, such as the drive transmission unit 20 catching the wire bundle 28 and tearing the cable sheath, is less likely to occur.

As described above, in a case where some of the plurality of screws 203 for fastening the drive transmission unit 20 are arranged in the gap between the drive transmission unit 20 and the high-voltage board unit 23, the wire bundle guide unit 30 is arranged between those screws 203 and the high-voltage board unit 23. In this embodiment, the lower guide plate 30b of the wire bundle guide unit 30 guides the wire bundle 28, which has been guided by the upper guide plate 30a, from the upper surface 300 of the lower guide plate 30b to the lower surface 301, and routes the wire bundle 28 with at least part of the wire bundle 28 covered by the lower guide plate 30b. Thereby, it is possible to properly arrange the wiring even in a case where there is difficulty securing a space for arranging the wire bundle 28.

In addition, in this embodiment, when removing the screw 203 of the drive transmission unit 20 by passing the screwdriver 50 through the gap between the drive transmission unit 20 and the high-voltage board unit 23, since the wire bundle 28 is covered by the lower guide plate 30b as described above, the wire bundle 28 is not caught by the screwdriver 50. Further, when mounting and dismounting the drive transmission unit 20, the wire bundle 28 is not caught by the drive transmission unit 20. As described above, even if the gap between the drive transmission unit 20 and the high-voltage board unit 23 is narrow, it is possible to reduce the likelihood of catching the wire bundle 28 during the mounting and dismounting operations of the drive transmission unit 20 fastened using the screw 203 which is arranged in the gap.

### OTHER EMBODIMENTS

To be noted, while, in the embodiment described above, the wire bundle 28 connected to the memory boards 27 is covered by the lower guide plate 30b, the wire bundle 28 covered by the lower guide plate 30b is not limited to this. For example, in a case of connecting the charging units 8Y to 8K and the charging high-voltage board 220 with cables, or in a case of connecting the developing units 4Y to 4K and the developing high-voltage board 221 with cables, the wire bundle can be a wire bundle in which these cables are bundled.

To be noted, while, in the embodiment described above, the image forming apparatus 100 using an intermediate transfer method, in which, after primarily transferring the toner images from the photosensitive drums 6Y to 6K of each color onto the intermediate transfer belt 14, the toner image is secondarily transferred from the intermediate transfer belt 14 onto the recording material S, is described as an example, it is not limited to this. The embodiment described above may be applied to image forming apparatuses using a direct transfer method that directly transfers the toner images from the photosensitive drums 6Y to 6K, which rotate while bearing the toner images, of each color to the recording material S.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-103521, filed Jun. 27, 2024 which is hereby incorporated by reference herein in its entirety.

What is claimed is:

1. An image forming apparatus comprising:
an image forming unit configured to form an image on a recording material;
a frame body;
a first unit secured to the frame body;
a cable; and
a guide unit configured to guide the cable,
wherein the guide unit includes a first guide portion having a first surface which faces to a first side of the first guide portion and a second surface which is opposite to the first surface and faces to a second side of the first guide portion, the second side being opposite to the first side in an intersecting direction that intersects with the first surface and the second surface,
wherein a first through hole penetrating from the first surface to the second surface is provided in the first guide portion,
wherein the first unit is arranged on the first side of the first guide portion, and
wherein the cable includes
a second-side part arranged on the second side of the first guide portion and along the second surface of the first guide portion, and
a first-side part drawn out from the second side through the first through hole to the first side of the first guide portion.

2. The image forming apparatus according to claim 1,
wherein the guide unit includes a second guide portion extending from the first surface of the first guide portion toward the first side of the first guide portion in the intersecting direction,
wherein the first unit includes a fastening portion that is configured to be fastened to the frame body with a fastening member,
wherein a second through hole is provided in the second guide portion, and
wherein the fastening portion of the first unit is inserted through the second through hole.

3. The image forming apparatus according to claim 2,
wherein a gap is provided between the first unit and the first surface of the first guide portion, the gap providing access of a tool used in fastening the fastening member to the fastening portion.

4. The image forming apparatus according to claim 1,
wherein the image forming unit includes a rotary member configured to rotate, and
wherein the first unit includes a drive motor configured to generate a driving force to rotate the rotary member, and a gear configured to transmit the driving force.

5. The image forming apparatus according to claim 4,
wherein the guide unit includes a second guide portion extending from the first surface of the first guide portion toward the first side of the first guide portion in the intersecting direction, and
wherein the second guide portion includes an engagement portion configured to engage with the drive motor.

6. The image forming apparatus according to claim 1,
wherein the image forming unit includes a charge unit, and
wherein the cable is electrically connected to the charge unit.

7. The image forming apparatus according to claim 6,
wherein the guide unit includes a second guide portion extending from the first surface of the first guide portion toward the first side of the first guide portion in the intersecting direction, and
wherein the second guide portion includes a charging unit contact configured to electrically connect the cable to the charge unit.

8. The image forming apparatus according to claim 1,
wherein the image forming unit includes a developing unit, and
wherein the cable is electrically connected to the developing unit.

9. The image forming apparatus according to claim 8,
wherein the guide unit includes a second guide portion extending from the first surface of the first guide portion toward the first side of the first guide portion in the intersecting direction, and
wherein a contact configured to electrically connect the cable to the developing unit is disposed on the second guide portion.

10. The image forming apparatus according to claim 1,
wherein the guide unit includes a plurality of first holding members configured to hold and guide the second-side part of the cable along the second surface of the first guide portion.

11. The image forming apparatus according to claim 10,
wherein the guide unit includes a second guide portion extending from the first surface of the first guide portion toward the first side of the first guide portion in the intersecting direction.

12. The image forming apparatus according to claim 11,
wherein the second guide portion is secure to the frame body, and
wherein the second guide portion includes a plurality of second holding members that are arranged on a surface of the second guide portion on a side opposite to the frame body and are configured to hold and guide the first-side part of the cable.

13. The image forming apparatus according to claim 1, further comprising:
an electrical board that is configured to input and output a signal,
wherein the first guide portion includes a relay connector configured to relay the signal from or to the electrical board, and
wherein the cable guided by the first guide portion is connected to the relay connector.

14. The image forming apparatus according to claim 1, further comprising:
a process cartridge replaceably disposed in the image forming apparatus, the process cartridge including the image forming unit; and
a memory board configured to store replacement information of the process cartridge,
wherein the cable is connected to the memory board.
